(19) United States
(12) Patent Application Publication
(10) Pub. No.: US 2013/0187075 A1
(43) Pub. Date: Jul. 25, 2013

(54) DIELECTRIC UNION VALVE FOR LIQUID PROPANE

(71) Applicant: Paul Craig, Birmingham, MI (US)

(72) Inventor: Paul Craig, Birmingham, MI (US)

(73) Assignee: JoMar International, Ltd., Warren, MI (US)

(21) Appl. No.: 13/745,979

(22) Filed: Jan. 21, 2013

Related U.S. Application Data
(60) Provisional application No. 61/589,531, filed on Jan. 23, 2012.

(51) Int. Cl. F17C 7/04; F16K 27/00; F17C 13/04

(52) U.S. Cl. CPC F17C 7/04; F17C 13/04; F16K 27/00
USPC 251/368

(57) ABSTRACT

A system for delivering propane from an outdoor liquid propane storage tank to a building structure is provided having a first pressure regulator mountable to an outdoor liquid propane storage tank, a metallic fuel line extending from the storage tank to the building structure, a second pressure regulator mountable to the building structure, and a union valve. The union valve mounted adjacent the second pressure regulator in the fluid flow path between the fuel line second end and the second regulator inlet, and having an ON and OFF position to enable the propane to be quickly turned off. The union valve including an integral dielectric member isolating the fuel line from the second fuel pressure regulator inlet, to provide a dielectric break between the building and the fuel line, without using a separate non electrically conductive fuel line section.

### CROSS-REFERENCE TO RELATED APPLICATIONS

This application claims the benefit of U.S. provisional Application No. 61/589,531 filed Jan. 23, 2012, the disclosure of which is incorporated in its entirety by reference herein.

### FIELD OF INVENTION

The invention relates to dielectric inserts for providing an electrical break in a metallic gaseous hydrocarbon fuel line.

### BACKGROUND

Liquid propane (LP) is used in many regions of the world as a source of fuel for residential and commercial heating and cooling systems. Liquid propane is commonly stored in pressurized tanks kept outside and spaced a safe distance from the building structure. Gaseous propane fuel is delivered to the building structure via a feed line which is commonly maintained underground. Since the liquid propane is maintained in a storage tank at a relatively high pressure, one or more regulators are located between the storage tank and the entry point exterior of the building structure so that the pressure of the gaseous propane entering the structure is approximately 11″ of water. In a single regulator system, the regulator would be located at the storage tank. In a dual regulator system, typically a first regulator, set at about 10 psig, is located at the storage tank and a second regulator is located at the building structure at the point of entry. In 2011, the NFPA (National Fire Protection Agency) introduced a dielectric break requirement for propane systems. In an effort to reduce the likelihood of spark induced propane fires, a dielectric break is placed in the metallic gas above ground line outside of the building structure, isolating the outside and inside gas lines.

### SUMMARY

A dielectric union valve is provided specifically adapted for use in liquid propane systems to meet the requirements of NFPA 58 2011 edition. The dielectric union valve is located outside of the building structure in order to electrically isolate the building structure from the metallic feed line bringing propane into the building. The dielectric union valve has internal dielectric components isolating the metallic inlet and outlet connections of the valve.

### BRIEF DESCRIPTION OF THE DRAWINGS

FIG. 1 is a schematic illustration of a liquid propane delivery system for a building; and

FIG. 2 is a cross-sectional side elevational view of a dielectric union valve.

### DETAILED DESCRIPTION

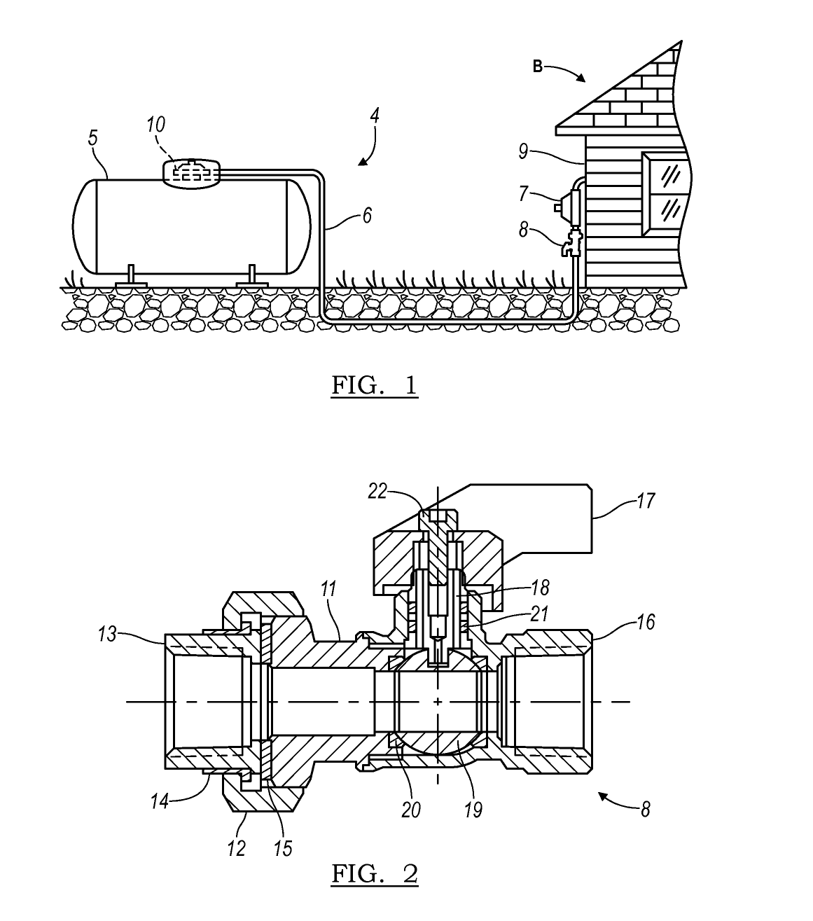

FIG. 1 illustrates a liquid propane delivery system 4 for providing propane to a building structure B. The LP propane system 4 includes a liquid propane tank 5 which is located outside of the building structure safely spaced a distance away from the building as required by local building code. A metallic propane feed line 6 extends between the LP tank 5 and building B, preferably located safely underground through the range of its travel as required by local building code. In one embodiment, a pressure regulator is located at a building structure on the outside of the building that is supplied by pressurized propane from feed line 6. A dielectric union valve 8 is interposed between feed line 6 and first regulator 7. Both the first regulator 7 and dielectric union valve 8 are located preferably on the exterior wall 9 of building B above ground level. A second pressure regulator 10 is located at the liquid propane (LP) tank 5 for supplying propane gas to feed line 6 at a desired line pressure, typically about 10 psig. First regulator 7 further reduces the pressure from the feed line pressure to the desired building pressure, typically 11″ of water.

Dielectric union valve 8 is shown in an exploded cross-sectional view in FIG. 2. The valve preferably has a two-piece brass body with an end connection 11 having an internal bore and a threaded connection for cooperating with a nut 12. Nut 12 retains threaded union end 13 in place securely mounted on the end connection 11. In order to provide a dielectric break between the union end 13 and end-connection 11, a dielectric ring 14 is provided about the periphery of dielectric union 8 and a dielectric gasket 15 is interposed between spaced apart faces on the end connection 11 and union end 13. Preferably, the dielectric ring 14 is made out of PA 66, a polyamide resin, and gasket 15 is made out of NBR, a rubber washer material. The resulting dielectric connection has a rating of approximately 1000 volts or higher.

The balance of the dielectric union valve 8 is of a generally conventional construction including a main valve body 16, external handle 17, connected to a valve stem 18 which rotates a ball 19 located within an internal cavity within the valve body 16, sealingly mounted between the pair of spaced apart annular seats 20. A pair of O-rings 21 sealingly mount stem 18 to the valve body 16. The handle 17 is held in place by a spline connection and screw 22 as illustrated. The resulting valve is referred to as a quarter-turn ball valve. The ball can be rotated 90 degrees between an open position as illustrated, to a closed position where all flow through the valve is blocked. Other valve structures, however, could be utilized to forming a dielectric union valve for use with liquid propane systems.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed:

1. A system for delivering propane from an outdoor liquid propane storage tank to a building structure, comprising:
a first pressure regulator mountable to an outdoor liquid propane storage tank, having an inlet to be connected to a liquid propane storage tank and an outlet for propane having a substantially constant first pressure;
a metallic fuel line having an inlet end connected to the first pressure regulator outlet, an outlet end and an elongate tubular section there between for extending from the storage tank to the building structure;
a second pressure regulator mountable to the building structure, having a propane inlet for receiving propane passing through the fuel line at the first pressure and an outlet for propane having a substantially constant lower second pressure; and
a union valve mounted adjacent the second pressure regulator in the fluid flow path between the fuel line second end and the second regulator inlet, the union valve having an ON and a OFF position to enable the propane supplied to the building structure to be quickly turned off, and further comprising one or more integral dielectric members dielectrically isolating an inlet of the union valve connected to the fuel line output and an outlet of the union valve connected to the second fuel pressure regulator inlet, to provide a dielectric break between the building and the fuel line, without using a separate non electrically conductive fuel line section.

2. The system of claim 1, wherein the union valve has a dielectric rating of at least approximately 1,000 volts.

3. The system of claim 1, wherein the union valve further comprises a valve body and an inlet coupling separated from one another by the one or more integral dielectric members.

4. The system of claim 3, wherein the one or more integral dielectric members comprise a tubular ring made of a plastic resin surrounding a section of the inlet coupling and a rubber like washer spacing an end of the inlet coupling from the valve body.

5. A union valve for use in a system for delivering propane from an outdoor liquid propane storage tank to a building structure, the union valve located in the propane flow path and mounted adjacent the pressure regulator at the building structure to provide a propane shut off, the union valve comprising:
a valve body defining an internal flow passageway with an inlet and an outlet, the outlet adapted to be connectable to the pressure regulator;
a flow regulating member located within the internal flow passageway and shiftable between an ON and an OFF position to enable the propane supplied to the building structure to be quickly turned off;
an inlet coupling which is connectable to the fuel line and in fluid communication with the valve body inlet, and;
one or more dielectric members, dielectrically isolating the valve body and the inlet coupling to provide a dielectric break between the building and the fuel line.

6. The union valve of claim 5 wherein the union valve has a dielectric rating of at least approximately 1,000 volts.

7. The union valve of claim 5 wherein the one or more integral dielectric members comprise a tubular ring made of a plastic resin surrounding the inlet coupling and a rubber like washer spacing an end of the inlet coupling from the valve body inlet.

8. The union valve of claim 7 wherein the union valve has a dielectric rating of at least approximately 1,000 volts.

9. The union valve of claim 7 wherein the tubular ring made of a plastic resin is formed of a polyamide.

10. The union valve of claim 9 wherein the rubber like washer is formed of a NBR material.
